(19) United States
(12) Patent Application Publication
(10) Pub. No.: US 2024/0026719 A1
(43) Pub. Date: Jan. 25, 2024

(54) FASTENED MEMBER, COATING JIG FOR THE SAME, AND METHOD OF COATING THE SAME

(71) Applicant: KUBOTA CORPORATION, Osaka (JP)

(72) Inventors: Daisuke MATSUMIYA, Osaka (JP); Ken SATO, Osaka (JP); Yasushi UCHIDA, Hiroshima (JP); Yuusaku MARUOKA, Hiroshima (JP)

(73) Assignee: KUBOTA CORPORATION, Osaka (JP)

(21) Appl. No.: 18/376,113

(22) Filed: Oct. 3, 2023

Related U.S. Application Data
(63) Continuation of application No. PCT/JP2022/008198, filed on Feb. 28, 2022.

(30) Foreign Application Priority Data
Apr. 5, 2021 (JP) 2021-064188

(51) Int. Cl. E05D 5/04; B05B 13/02; B05B 12/28

(52) U.S. Cl. CPC E05D 5/043; B05B 13/0292; B05B 12/28; E05Y 2900/518

(57) ABSTRACT

A fastened member such as a hinge which is a metal fastened member to be fastened with at least one fastener to at least one attachment surface of at least one target object such as a construction machine to which the fastened member is to be attached, the at least one target object containing steel, the fastened member including at least one contact surface to make contact with the at least one attachment surface, the at least one contact surface at least partially including at least one exposure portion where material having a higher ionization tendency than steel is exposed, wherein a portion of the fastened member that is other than the at least one contact surface is coated with a coating.

### CROSS REFERENCE TO RELATED APPLICATIONS

This application is a continuation application of International Application No. PCT/JP2022/008198, filed on Feb. 28, 2022, which claims the benefit of priority to Japanese Patent Application No. 2021-064188, filed on Apr. 5, 2021. The entire contents of each of these applications are hereby incorporated herein by reference.

### BACKGROUND OF THE INVENTION

### 1. Field of the Invention

The present invention relates to a fastened member and a coating jig therefor, and a method of coating the fastened member.

### 2. Description of the Related Art

A cabin of a backhoe disclosed in Japanese Unexamined Patent Application Publication No. 2018-69867 (see FIG. 1) is known as a target object having a fastened member such as a hinge attached.

The backhoe cabin disclosed in Japanese Unexamined Patent Application Publication No. 2018-69867 has a door on one side, and a door frame is rotatably attached to the cabin frame via hinge(s). With regard to such a cabin, the door frame, the hinge(s), and the cabin frame are usually made of steel.

In an assembly process of such a cabin, the entire cabin, i.e., the cabin frame, the door frame, and the hinge(s), are usually coated at the same time after the uncoated hinge(s) is/are attached to the uncoated door frame and cabin frame.

### SUMMARY OF THE INVENTION

However, with a configuration in which a door frame made of steel is attached to a cabin frame made of steel via an uncoated hinge and then the entire cabin is coated like the known technique described above, the following occurs. Uncoated material (steel) is left exposed at the attachment surface for the hinge of the cabin frame, the attachment surface for the hinge of the door frame, and the contact surfaces of the hinge that are in contact with the attachment surfaces, and therefore, if water or other substances penetrate the gap between the attachment surfaces and the contact surfaces during outdoor work, the attachment surfaces and the contact surfaces may rust.

Preferred embodiments of the present invention provide a fastened member that can prevent or reduce rusting on attachment surface(s) of target object(s) to which the fastened member is attached and on contact surface(s) of the fastened member that is/are in contact with this attachment surface(s).

Preferred embodiments of the present invention provide a coating jig and a coating method that make it possible to efficiently coat such fastened member(s).

A fastened member according to a preferred embodiment of the present invention is a metal fastened member to be fastened with at least one fastener to at least one attachment surface of at least one target object to which the fastened member is to be attached, the at least one target object containing steel, the fastened member including at least one contact surface to make contact with the at least one attachment surface, the at least one contact surface at least partially including at least one exposure portion where material having a higher ionization tendency than steel is exposed, wherein a portion of the fastened member that is other than the at least one contact surface is coated with a coating.

The fastened member may be configured such that the at least one contact surface is coated with the coating except for the at least one exposure portion.

The at least one contact surface may have at least one insertion hole for insertion of the at least one fastener.

The fastened member may be a hinge including a pin and first and second pivotable plates coupled to each other via the pin such that the first and second pivotable plates are pivotable relative to each other.

The at least one contact surface may be plated with a layer of the material having a higher ionization tendency than steel, and the layer of the material may be exposed in the at least one exposure portion.

The at least one contact surface may be provided with a thin sheet at least a surface of which contains the material having a higher ionization tendency than steel, and the surface of the thin sheet may be exposed in the at least one exposure portion.

A coating jig according to a preferred embodiment of the present invention is a coating jig for at least one fastened member described above, the coating jig including a masking member having at least one masking surface to contact and cover the at least one exposure portion of the at least one fastened member.

The coating jig may further include at least one masking piece including the at least one masking surface whose area is adjustable.

The masking member may be a plate. The plate may have the at least one masking surface on each of opposite sides thereof

The at least one fastened member may be at least one hinge each including a pin and first and second pivotable plates coupled to each other via the pin such that the first and second pivotable plates are pivotable relative to each other. The coating jig, in which a plurality of the masking surfaces include at least one first masking surface and at least one second masking surface, may include at least one first portion including the at least one first masking surface to cover the at least one exposure portion of the first pivotable plate, at least one second portion including the at least one second masking surface to cover the at least one exposure portion of the second pivotable plate, and at least one third portion located between the at least one first portion and the at least one second portion and each including at least one opening or at least one cutout through which the pin is exposed.

The coating jig may include a plurality of the masking surfaces, and may be configured such that when the number of the at least one fastened member is one and the one fastened member includes a plurality of the exposure portions, the plurality of masking surfaces cover the plurality of exposure portions of the one fastened member at the same time, or when the number of the at least one fastened member is two or more, the plurality of masking surfaces cover the at least one exposure portion of each of the two or more fastened members at the same time.

A coating method according to a preferred embodiment of the present invention is a method of coating the at least one fastened member using the coating jig, the method including: an attaching step including attaching the at least one fastened member to the coating jig before performing coating such that the at least one exposure portion is in contact with the at least one masking surface; and a coating step including, after the attaching step, coating the at least one fastened member attached to the coating jig.

In the coating method, the attaching step may include allowing a peripheral portion of the at least one contact surface to be left exposed without being covered. The coating step may include coating the peripheral portion of the at least one contact surface.

The masking member may be a plate which has the at least one masking surface on each of opposite sides thereof. The attaching step may include attaching a plurality of the fastened members to the coating jig such that the at least one exposure portion of at least one of the plurality of fastened members is in contact with the at least one masking surface on one of the opposite sides of the masking member and that the at least one exposure portion of at least another of the plurality of fastened members is in contact with the at least one masking surface on the other of the opposite sides of the masking member. The coating step may include coating the at least one of the plurality of fastened members and the at least another of the plurality of fastened members.

The at least one fastened member may be at least one hinge each including a pin and first and second pivotable plates coupled to each other via the pin such that the first and second pivotable plates are pivotable relative to each other. The coating jig, in which a plurality of the masking surfaces include at least one first masking surface and at least one second masking surface, may include at least one first portion including the at least one first masking surface to cover the at least one exposure portion of the first pivotable plate, at least one second portion including the at least one second masking surface to cover the at least one exposure portion of the second pivotable plate, and at least one third portion located between the at least one first portion and the at least one second portion and each including at least one opening or at least one cutout through which the pin is exposed. The attaching step may include attaching the at least one fastened member to the coating jig such that the at least one exposure portion of the first pivotable plate is in contact with the at least one first masking surface of the at least one first portion, and the at least one exposure portion of the second pivotable plate is in contact with the at least one second masking surface of the at least one second portion. The coating step may include coating a portion of the first pivotable plate that is not in contact with the at least one first masking surface, the pin, and a portion of the second pivotable plate that is not in contact with the at least one second masking surface.

The at least one first portion and the at least one second portion may be plates. The at least one first portion may have the at least one first masking surface on one of opposite sides thereof, and have, on the other of the opposite sides thereof, one of (i) at least one other first masking surface and (ii) at least one other second masking surface. The at least one second portion may have the at least one second masking surface on one of opposite sides thereof, and have, on the other of the opposite sides thereof, the other of (i) the at least one other first masking surface and (ii) the at least one other second masking surface. The attaching step may include allowing the at least one exposure portion of the first pivotable plate of at least one of a plurality of the fastened members to be in contact with the at least one first masking surface on the one of the opposite sides of the at least one first portion, and allowing the at least one exposure portion of the second pivotable plate of the at least one of the plurality of fastened members to be in contact with the at least one second masking surface on the one of the opposite sides of the at least one second portion, when the at least one other first masking surface is on the other of the opposite sides of the at least one first portion, allowing the at least one exposure portion of the first pivotable plate of at least another of the plurality of fastened members to be in contact with the at least one other first masking surface, and allowing the at least one exposure portion of the second pivotable plate of the at least another of the plurality of fastened members to be in contact with the at least one other second masking surface on the other of the opposite sides of the at least one second portion, and when the at least one other second masking surface is on the other of the opposite sides of the at least one first portion, allowing the at least one exposure portion of the second pivotable plate of the at least another of the plurality of fastened members to be in contact with the at least one other second masking surface, and allowing the at least one exposure portion of the first pivotable plate of the at least another of the plurality of fastened members to be in contact with the at least one other first masking surface on the other of the opposite sides of the at least one second portion. The coating step may include coating a portion of the first pivotable plate that is not in contact with the at least one first masking surface, the pin, and a portion of the second pivotable plate that is not in contact with the at least one second masking surface, of each of the at least one of the plurality of fastened members and the at least another of the plurality of fastened members.

The coating jig may include a plurality of the masking surfaces. The attaching step may include attaching a plurality of the fastened members to the coating jig such that the at least one exposure portion of each of the plurality of fastened members is in contact with any of the plurality of masking surfaces. The coating step may include coating each of the plurality of fastened members.

The at least one fastened member may have at least one insertion hole for insertion of the at least one fastener. The attaching step may include attaching the at least one fastened member to the coating jig by inserting the at least one fastener for attachment into the at least one insertion hole.

The masking member may be a plate which has the at least one masking surface on each of opposite sides thereof. The attaching step may include, by inserting the at least one fastener into the at least one insertion hole of at least one of a plurality of the fastened members and into the at least one insertion hole of at least another of the plurality of fastened members such that the masking member is provided between the at least one of the plurality of fastened members and the at least another of the plurality of fastened members, attaching the at least one of the plurality of fastened members and the at least another of the plurality of the fastened members to the coating jig.

The above and other elements, features, steps, characteristics and advantages of the present invention will become more apparent from the following detailed description of the preferred embodiments with reference to the attached drawings.

### BRIEF DESCRIPTION OF THE DRAWINGS

A more complete appreciation of preferred embodiments of the present invention and many of the attendant advantages thereof will be readily obtained as the same becomes better understood by reference to the following detailed description when considered in connection with the accompanying drawings described below.

FIG. 1 is a side view of a backhoe including a hinge according to a first embodiment of the present invention.

FIG. 2 is a perspective view of a cabin of the backhoe in FIG. 1.

FIG. 3 is an exploded perspective view of the hinge and its vicinity in FIG. 1.

FIG. 4 is a horizontal cross-sectional view of the hinge and its vicinity in FIG. 3.

FIG. 5 is a perspective view of the hinge in FIG. 3.

FIG. 6 is an exploded perspective view of a hinge according to a second embodiment of the present invention.

FIG. 7 is a perspective view of a hinge according to a third embodiment of the present invention.

FIG. 8 is a side view of a coating jig according to a first embodiment of the present invention.

FIG. 9 is a cross-sectional view taken along line IX-IX in FIG. 8.

FIG. 10 is a perspective view of the coating jig in FIG. 8.

FIG. 11 is a perspective view of a coating jig according to a second embodiment of the present invention.

FIG. 12 is a horizontal cross-sectional view of the coating jig in FIG. 11.

FIG. 13 is a side view of a coating jig according to a third embodiment of the present invention.

FIG. 14 is a side view of the coating jig in FIG. 13.

FIG. 15 is a cross-sectional view taken along line XV-XV in FIG. 14.

FIG. 16 is a side view of a coating jig according to a fourth embodiment of the present invention.

FIG. 17 is a cross-sectional view taken along line XVII-XVII in FIG. 16.

FIG. 18 is a side view of a coating jig according to a fifth embodiment of the present invention.

FIG. 19 is a side view of the coating jig in FIG. 18.

FIG. 20 is a cross-sectional view taken along line XX-XX in FIG. 19.

FIG. 21 is a side view of a coating jig according to a variation of the present invention.

FIG. 22 is a side view of a first masking piece and a second masking piece in FIG. 21.

### DETAILED DESCRIPTION OF THE PREFERRED EMBODIMENTS

The preferred embodiments will now be described with reference to the accompanying drawings, wherein like reference numerals designate corresponding or identical elements throughout the various drawings. The drawings are to be viewed in an orientation in which the reference numerals are viewed correctly.

The following discusses embodiments of a fastened member, embodiments of a coating jig, and examples of a coating method according to the present invention with reference to the drawings. In the following embodiments, similar elements are assigned identical reference signs and descriptions therefor are not repeated.

### First Embodiment of a Fastened Member

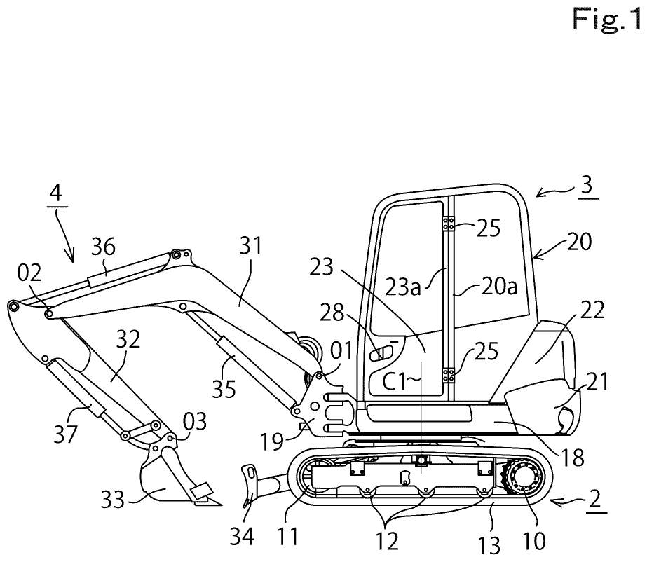

FIGS. 1 to 5 illustrate a cabin 20 and a hinge (fastened member) 25 of a backhoe to which the hinge 25 is attached. A fastened member according to a first embodiment of the present invention will be described with reference to FIGS. 1 to 5.

### Overview of the Entire Backhoe

FIG. 1 is a side view of a backhoe including hinges 25 according to the first embodiment of the present invention. The backhoe in FIG. 1 includes a traveling device 2, a swivel body 3 rotatably supported on the traveling device 2, and a front working device 4 provided at the front end of the swivel body 3.

The traveling device 2 in FIG. 1 is a crawler traveling device (crawler type), and includes a pair of left and right travel mechanisms each including a driving wheel 10 at the rear end, a driven wheel 11 at the front end, a plurality of rolling wheels 12, and an endless crawler 13 that is wrapped on the driving wheel 10, the driven wheel 11, and the rolling wheels 12. The driving wheel 10 is connected to a hydraulic motor for travel (not illustrated) such that power can be transmitted through an appropriate transmission device. A dozer (blade) 34 is provided at the front end of the traveling device 2.

The swivel body 3 in FIG. 1 includes a machine body (swivel base) 18 supported on the traveling device 2 rotatably about a rotation axis Cl, a cabin 20 on the machine body 18, a balance weight 21 at a rear portion of the machine body 18, and a hood 22 containing a prime mover and/or the like (not illustrated).

The front working device 4 in FIG. 1 includes a boom 31 supported on a support bracket 19 provided at the front end of the machine body 18 such that the boom 31 is swingable about the first horizontal axis 01, an arm 32 supported at the distal end of the boom 31 such that the arm 32 is swingable about a second horizontal axis 02, and a bucket 33 supported at the distal end of the arm 32 such that the bucket 33 is swingable about a third horizontal axis 03. It is noted here that a hydraulic cylinder 35 for the boom is provided between the boom 31 and the support bracket 19, and the boom 31 is caused to swing up or down by the extension or retraction of the hydraulic cylinder 35 for the boom. A hydraulic cylinder 36 for the arm is provided between the boom 31 and the arm 32, and the arm 32 is caused to swing relative to the boom 31 by extension or retraction of the hydraulic cylinder 36 for the arm. Furthermore, a hydraulic cylinder 37 for the bucket is provided between the arm 32 and the bucket 33, and the bucket 33 is caused to swing relative to the arm 32 by the extension or retraction of the hydraulic cylinder 37 for the bucket.

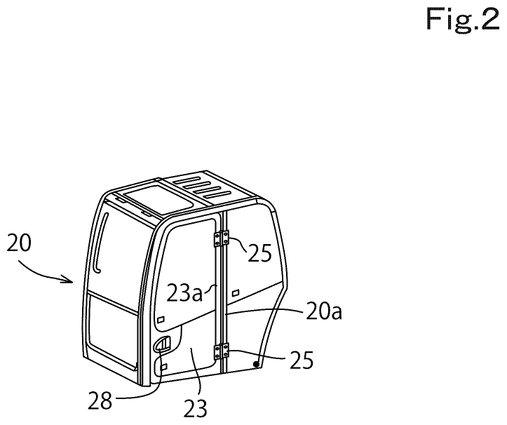

FIG. 2 is a perspective view of the cabin 20 of the backhoe in FIG. 1 as seen diagonally from front and above. In the cabin 20 of FIG. 2, an operator's seat, operating device(s) (manual operator(s)), and work manipulator(s) (which are not illustrated) are arranged so that the operator can perform travel and work while seated. It is noted here that the cabin 20 in FIG. 2 includes transparent window(s), peripheral wall(s), and the like provided on a cabin frame 20a made of steel. A door 23 is provided on the left side of the cabin 20 to allow the operator to enter and exit. The rear end of a steel door frame 23a of the door 23 is rotatably attached to the cabin frame 20a via a pair of upper and lower hinges 25, which are fastened members. A handle 28 made of a metal is attached to the door 23.

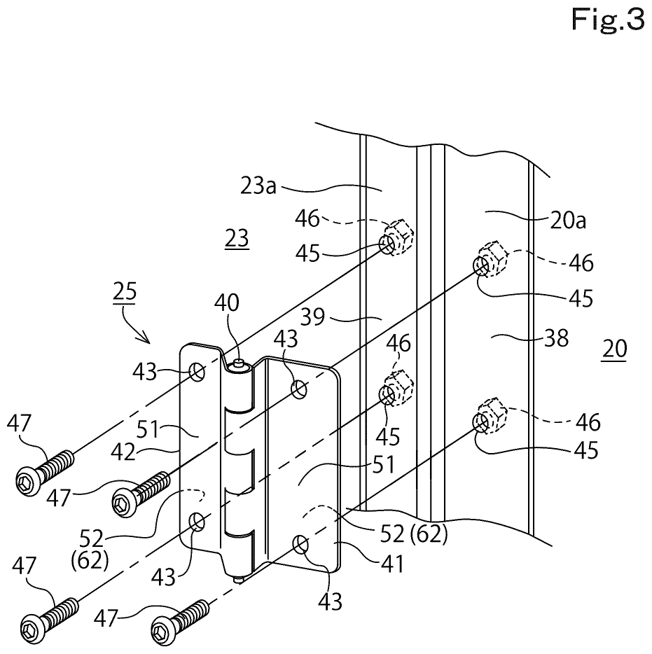

FIG. 3 is an enlarged exploded perspective view of one of the hinges 25 and its vicinity in FIG. 1. The hinge 25 here is depicted such that the hinge 25 is separated from the cabin frame 20a and the door frame 23a. As illustrated in FIG. 3, planar attachment surfaces 38 and 39 for attachment with the hinge 25 are provided on the outdoor surface of the cabin frame 20a and the outdoor surface of the door frame 23a, respectively. Each attachment surface 38, 39 has a pair of upper and lower bolt insertion holes 45. Nuts 46 are arranged concentrically with the respective bolt insertion holes 45 on the back side of the attachment surfaces 38 and 39, and are fixed by welding to the cabin frame 20a and the door frame 23a. Note that the nuts 46 may be configured such that the nuts 46 are not fixed to the door frame 23a or the cabin frame 20a by welding or the like.

The hinge 25 in FIG. 3 is a metal hinge. In the present embodiment, the hinge as a fastened member is made of steel like the cabin frame 20a, and includes a pin 40 and first and second pivotable plates 41 and 42 which are coupled to each other via the pin 40 such that the first and second pivotable plates 41 and 42 are pivotable relative to each other. The first pivotable plate 41 and the second pivotable plate 42 have bolt insertion holes 43 at locations corresponding to the bolt insertion holes 45 in the attachment surfaces 38 and 39, respectively.

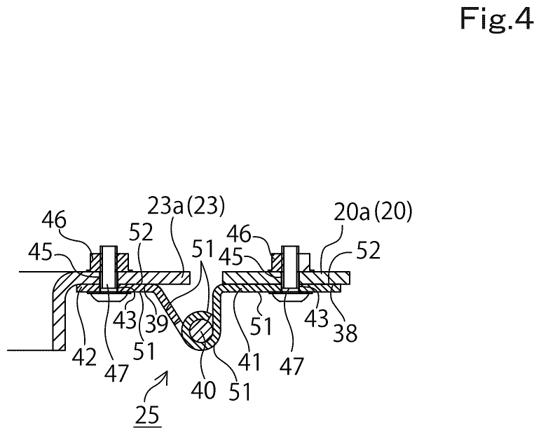

FIG. 4 is a horizontal cross-sectional view of the hinge 25 in FIG. 3 and its vicinity. As illustrated in FIG. 4, when the hinge 25 is attached to the cabin frame 20a and the door frame 23a, a contact surface 52 of the first pivotable plate 41 contacts the attachment surface 38 of the cabin frame 20a, and a contact surface 52 of the second pivotable plate 42 contacts the attachment surface 39 of the door frame 23a. The door frame 23a is attached to the cabin frame 20a via the hinge 25 by inserting bolts (fasteners) 47 into the bolt insertion holes 43 and 45 and screwing the nuts 46 onto the bolts 47 while maintaining the above-described state.

It is noted here that the entire surface of the hinge 25 is coated except for the contact surfaces 52 of the first pivotable plate 41 and the second pivotable plate 42. That is, the pin 40, a peripheral surface in the vicinity of the pin 40, the obverse surface of the first pivotable plate 41 (the opposite surface of the first pivotable plate 41 from the contact surface 52), and the obverse surface of the second pivotable plate 42 (the opposite surface of the second pivotable plate 42 from the contact surface 52) are coated with a coating 51.

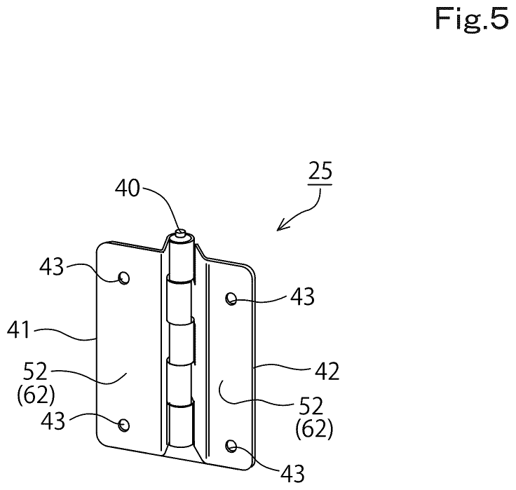

FIG. 5 is a perspective view of the hinge 25 in FIG. 3 as viewed from the contact surface 52 side. The hinge 25 in FIG. 5 is configured such that the area of the contact surface 52 of the first pivotable plate 41 is larger than the area of the contact surface 52 of the second pivotable plate 42. Specifically, the contact surfaces 52 have the same vertical length, but the first pivotable plate 41 is greater than the second pivotable plate 42 in terms of a width in a direction perpendicular to the pin 40.

The entire contact surface 52 of the first pivotable plate 41 and the entire contact surface 52 of the second pivotable plate 42 are not coated as described above. The entire contact surfaces 52 are plated with a layer of zinc in the present embodiment. With this, the contact surfaces 52 are exposure portions 62 where the layer of zinc is exposed. Zinc exposed in the exposure portions 62 is a metal with a higher ionization tendency than steel. Therefore, when zinc is in contact with a steel member, zinc acts as a sacrificial anode and prevents steel from rusting.

In the present embodiment, the exposure portions 62 of the contact surfaces 52 are achieved by zinc plating, but the present invention is not limited as such. For example, the plating may include metal(s) having a higher ionization tendency than steel, such as manganese, aluminum, and/or magnesium.

### Effect(s) of the Present Embodiment

Since backhoes are often used for outdoor work such as work at construction sites or civil engineering construction sites, the outer surfaces of the cabin 20 and the door 23 are often exposed to water and mud. During work, even if water or the like enters the gap between the hinge 25 and the door frame 23a or the gap between the hinge 25 and the cabin frame 20a, since the contact surfaces 52 of the hinge 25 are exposure portions 62 where a layer of zinc which has a higher ionization tendency than steel is exposed, the layer of zinc of the exposure portions 62 acts as a sacrificial anode. This makes it possible to eliminate or reduce the likelihood that the attachment surface 38 of the steel cabin frame 20a, the attachment surface 39 of the steel door frame 23a, and the steel material of the hinge 25, which are in contact with the layer of zinc, will rust.

The surfaces of the hinge 25 except for the contact surfaces 52 are coated with the coating 51 before attachment to the cabin 20 and the door 23. Therefore, as compared to known technology in which an uncoated hinge 25 is coated together with the cabin frame 20a and the door frame 23a after attachment, there are no uncoated portions, making it possible to maintain good appearance in the vicinity of the hinge. Furthermore, since the coating can be performed during the production process in the factory, the quality of the coating 51 can be improved.

### Second Embodiment of Fastened Member

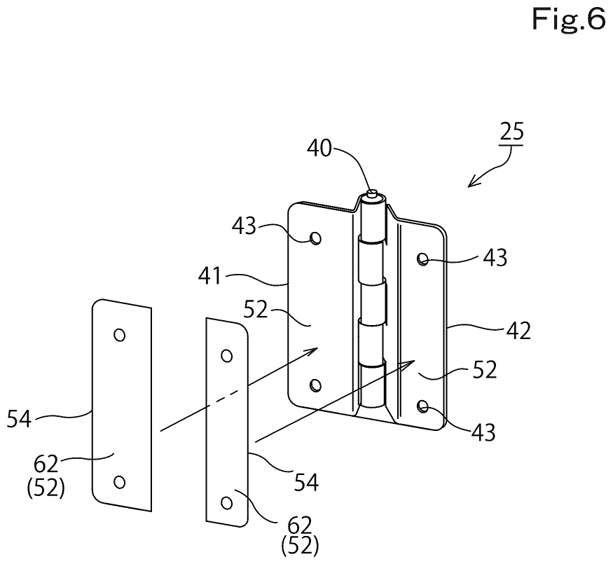

FIG. 6 illustrates a hinge 25 according to a second embodiment of the present invention, and is an exploded perspective view of the hinge 25 as viewed from the contact surface side. It is noted here that the hinge 25 as a fastened member according to the second embodiment in FIG. 6 differs from the hinge 25 according to the first embodiment in FIG. 3 in that the exposure portions 62 of the contact surfaces 52 are not achieved by plating, but are achieved by attaching thin sheets 54 to the contact surfaces 52 of the hinge 25 in the form of a raw material. It is noted here that the surfaces of the thin sheets 54 function as the contact surfaces 52. Each thin sheet 54 is a thin sheet at least the surface (contact surface 52) of which is made of material having a higher ionization tendency than steel. In the present embodiment, the thin sheet 54 is a thin zinc sheet. Note that, in the present embodiment, thin sheets 54 made of zinc are used to form the exposure portions 62 where zinc is exposed, but the present invention is not limited as such. For example, seal or tape made of material with a higher ionization tendency than steel such as zinc may be attached to the contact surfaces of the hinge 25 in the form of a raw material to form exposure portions 62 where the material such as zinc is exposed.

With this configuration, the exposure portions 62 where zinc is exposed can be easily formed simply by attaching thin sheets 54 made of zinc and/or the like, and, as compared to the first embodiment, there is no need for plating, making it possible to reduce cost and labor.

### Third Embodiment of Fastened Member

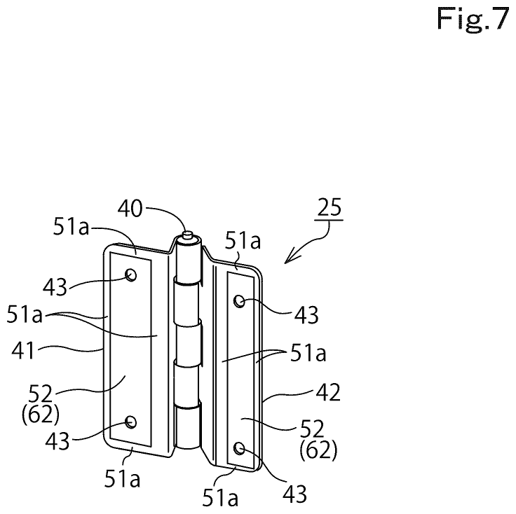

FIG. 7 is a perspective view of a hinge (fastened member) 25 according to a third embodiment of the present invention, as viewed from the contact surface 52 side. The hinge in FIG. 7 differs from the hinge 25 according to the second embodiment in FIG. 6 in that a coating 51a is provided over substantially the entire peripheral portions of the contact surfaces 52 such that the coating 51a has a width of several to several tens of millimeters, instead of leaving the contact surfaces 52 entirely exposed. That is, the contact surfaces 52 are coated with the coating 51a except for the exposure portions 62. Therefore, as compared to the hinge 25 according to the first embodiment, it is possible to further reduce the area of the exposure portions 62.

When the outer periphery of the contact surfaces 52 is surrounded by the coating 51a as illustrated in FIG. 7, it is possible to reduce the possibility that water or the like will enter the gap between the exposure portions 62 of the contact surfaces 52 of the hinge 25 and the attachment surfaces 38 and 39 of the door frame 23a and the cabin frame 20a when the hinge 25 is attached to the cabin frame 20a and the door frame 23a and the like, thus improving the effect of preventing rust from occurring. This also improves the appearance in the vicinities of the attachment surfaces 38 and 39. The coating 51a does not need to be provided over the entire peripheral portions of the contact surfaces 52, and may be provided, for example, only on opposite end portions of each contact surface 52 in the axial direction of the pin 40, only on opposite side portions of each contact surface 52 in a direction perpendicular to the pin 40, or the like.

### Other Embodiments of Fastened Member

(1) In each of the above-described embodiments of a fastened member, the fastened member is a hinge. Note, however, that the fastened member can be any of various other small parts such as the handle 28 of the cabin 20 in FIG. 2 and handrails.

(2) In each of the above-described embodiments, bolts are used as fasteners to fasten the fastened member. Note, however, that fastener(s) such as rivet(s) and/or clamp(s) can be used.

### First Embodiment of Coating Jig

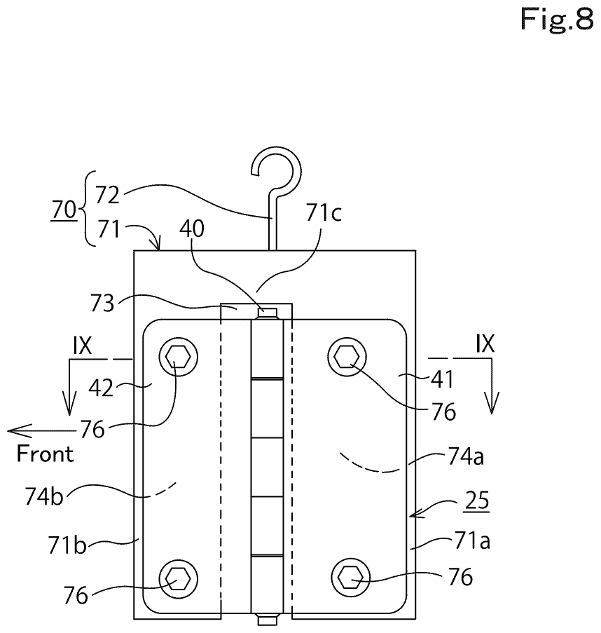

FIGS. 8 to 10 show a first embodiment of a coating jig 70 according to the present invention. The first embodiment of the coating jig will be described with reference to FIGS. 8 to 10. Note that, in the present embodiment and subsequent embodiments, one of the horizontal directions along the surface of the coating jig 70 is defined as the “front” of the coating jig 70 as indicated by arrow in the drawings, and the left side when the coating jig 70 is viewed from the rear is defined as the “left side” of the coating jig 70 as indicated by arrow.

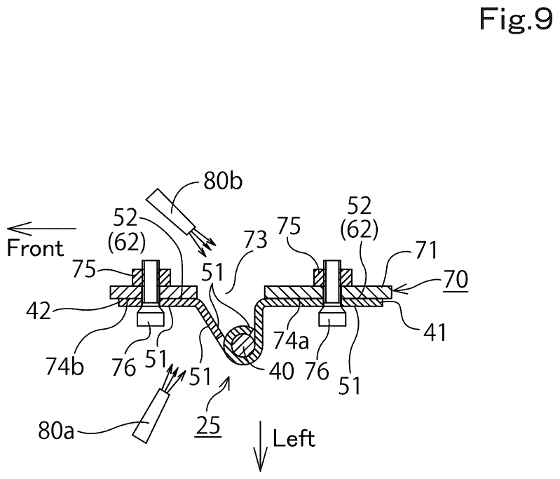

FIG. 8 is a side view of the coating jig 70 according to the first embodiment of the present invention, and FIG. 9 is a cross-sectional view taken along line IX-IX in FIG. 8. In FIGS. 8 and 9, a first masking surface 74a and a second masking surface 74b cover the contact surface 52 of the first pivotable plate 41 and the contact surface 52 of the second pivotable plate 42 of the hinge 25 when the hinge 25 is attached. The first masking surface 74a and the second masking surface 74b each also function as an attachment surface for attachment of the hinge 25 during coating. That is, when the hinge 25 before coating is attached to a masking member 71, the contact surfaces 52 of the hinge 25 contact the first masking surface 74a and the second masking surface 74b, and the contact surfaces 52 are covered to protect against sprayed paint. It is noted here that the coating jig 70 includes the masking member 71 having the first masking surface 74a and the second masking surface 74b to contact and cover the exposure portions 62 of the hinge 25 as a fastened member.

With this configuration, since the coating jig 70 itself includes masking surface(s) and has the hinge (fastened member) 25 attached thereto, it is possible to attach and cover the hinge 25 at the same time, making it possible to simplify the work of attaching the hinge 25 when performing coating.

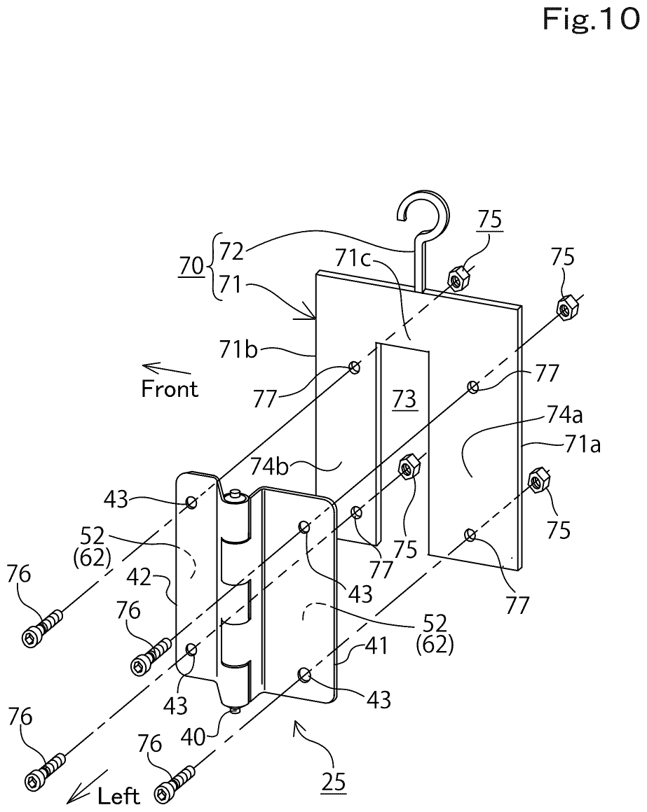

FIG. 10 is a perspective view illustrating the coating jig 70 in FIG. 8 separated from the hinge 25. The coating jig 70 in FIG. 10 includes the flat inverted U-shaped masking member 71 having a cutout 73, and a hanging hook 72 provided at the upper end of the masking member 71. The masking member 71 includes a first portion 71a provided at the rear and including the first masking surface 74a to cover the exposure portion 62 of the first pivotable plate 41, a second portion 71b provided at the front including the second masking surface 74b to cover the exposure portion 62 of the second pivotable plate 42, and a third portion 71c located between the first portion 71a and the second portion 71b and including the cutout 73 where the pin 40 is exposed. That is, a plurality of masking surfaces are provided, and a plurality of exposure portions 62 of a single hinge (fastened member) 25 can be covered at the same time by the plurality of masking surfaces (74a, 74b).

As illustrated in FIG. 10, the first masking surface 74a and the second masking surface 74b are located on the left side of the masking member 71. The first masking surface 74a of the first portion 71a covers the wide contact surface 52 of the first pivotable plate 41 of the hinge 25. The second masking surface 74b of the second portion 71b covers the narrow contact surface 52 of the second pivotable plate 42 of the hinge 25. It is noted here that the first masking surface 74a and the second masking surface 74b each have bolt insertion holes 77 at locations corresponding to the bolt insertion holes 43 of the hinge 25. Note that the cutout 73 of the third portion 71c is provided such that the right portion of the pin 40 and its vicinity is exposed when the hinge is attached and paint can be sprayed from the right side.

### (Method of Attaching and Coating Hinge 25 and Effect(s) Thereof)

Referring to FIG. 10, in an attaching step preceding coating, the contact surface 52 of the first pivotable plate 41 of the hinge 25 is brought into contact with the first masking surface 74a of the masking member 71, and the contact surface 52 of the second pivotable plate 42 of the hinge 25 is brought into contact with the second masking surface 74b of the masking member 71. The pin 40 is positioned in the cutout 73 of the third portion 71c. Next, four bolts (attaching fasteners) 76 are inserted into the bolt insertion holes 43 of the hinge 25 and the bolt insertion holes 77 of the masking member 71, and nuts 75 are screwed onto them, thus attaching the hinge 25 to the masking member 71. With this, the masking member 71 not only holds the hinge 25 but also covers the exposure portions 62 of the contact surfaces 52 during paint spraying.

In FIG. 9, in a coating step involving coating the hinge 25, one or more pairs of left and right coating nozzles 80a and 80b in a coating chamber are used to spray paint (coating) onto substantially the entire region of the hinge 25 except for the covered regions, from both the left and right sides of the masking member 71 and the hinge 25. The paint sprayed from the left coating nozzle(s) 80a adheres to the obverse side of the first pivotable plate 41, the obverse side of the second pivotable plate 42, and the obverse side of the portion including the pin 40 to form a coating 51. On the contrary, the paint sprayed from the right coating nozzle(s) 80b passes through the cutout 73 and adheres to the reverse side of the pin 40 to form a coating 51 in the vicinity of the reverse side of the pin 40. That is, in the coating step, the entire region of the hinge 25, except for the two contact surfaces 52, is efficiently coated. It follows that the surface except for the two covered contact surfaces 52, including the vicinity of the pin 40, is provided with the good quality coating 51, without leaving uncoated portions. Note that a single coating nozzle may be used to coat the opposite surfaces of the hinge 25, instead of using one or more pairs of coating nozzles.

### Second Embodiment of Coating Jig

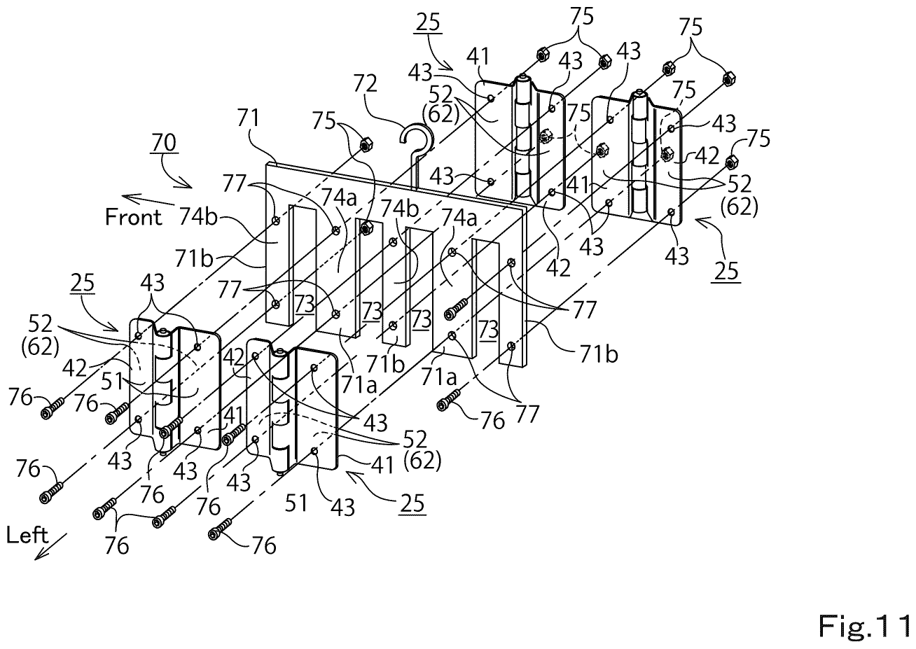

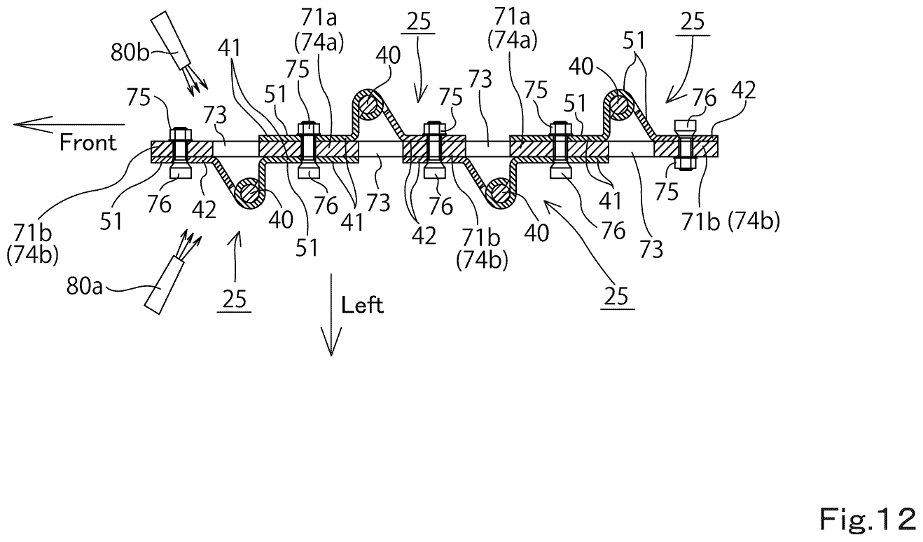

FIGS. 11 and 12 illustrate a second embodiment of a coating jig according to the present embodiment. The second embodiment of a coating jig will be described with reference to FIGS. 11 and 12. The same components and portions as those of the coating jig described in the first embodiment are assigned identical reference signs, and descriptions therefor are not repeated.

FIG. 11 is a perspective view of the coating jig 70 according to the second embodiment of the present invention, which is separated from hinges 25. The coating jig 70 in FIG. 11 differs from the coating jig 70 in FIG. 8 in that the masking member 71 in FIG. 11 has a rectangular shape longer in the front-rear direction than the coating jig 70 in FIG. 8 and that the masking member 71 in FIG. 11 has four cutouts 73 arranged at intervals in the front-rear direction. It is noted here that first portions 71a and second portions 71b are arranged such that each cutout 73 is located between a corresponding first portion 71a and a corresponding second portion 71b in the front-rear direction. Specifically, a second portion 71b, a cutout 73, a first portion 71a, a cutout 73, a central second portion 71b, a cutout 73, a first portion 71a, a cutout 73, and a second portion 71b are provided in this order from the front. Each first portion 71a includes first masking surfaces 74a on both the left and right sides, and the central second portion 71b also includes second masking surfaces 74b on both the left and right sides. The second portions 71b at the front and rear each include a second masking surface 74b only on one side thereof. Thus, two hinges 25 can be attached to the left side of the masking member 71, and two hinges 25 can be attached to the right side of the masking member 71. The four hinges 25 in total can be attached to the masking member 71 and coated at the same time. Six or more cutouts 73 may be provided at intervals along the front-rear direction. In such a case, six or more hinges 25 can be attached to the masking member 71 and coated at the same time. That is, a plurality of masking surfaces are provided, and a plurality of exposure portions 62 of a plurality of hinges (fastened members) can be covered at the same time by the plurality of masking surface.

### (Method of Attaching and Coating Hinges 25 and Effect(s) Thereof)

Referring to FIG. 11, in the attaching step preceding coating, with regard to the hinge 25 located at the front left of the masking member 71, the contact surface 52 of the second pivotable plate 42 is brought into contact with the left second masking surface 74b of the portion second portion 71b which is the foremost portion of the masking member 71, and the contact surface 52 of the first pivotable plate 41 is brought into contact with the left first masking surface 74a of the first portion 71a which is the second foremost portion of the masking member 71.

With regard to the hinge 25 located at the rear left of the masking member 71, the contact surface 52 of the second pivotable plate 42 is brought into contact with the left second masking surface 74b of the central second portion 71b (which is the third foremost portion) of the masking member 71, and the contact surface 52 of the first pivotable plate 41 is brought into contact with the left first masking surface 74a of the first portion 71a which is the fourth foremost portion of the masking member 71.

The two hinges 25 located at the right of the masking member 71 are arranged such that they are displaced rearward from the two left hinges 25, respectively. Specifically, with regard to the hinge 25 located at the front right of the masking member 71, the contact surface 52 of the first pivotable plate 41 is brought into contact with the right first masking surface 74a of the first portion 71a which is the second foremost portion of the masking member 71, and the contact surface 52 of the second pivotable plate 42 is brought into contact with the right second masking surface 74b of the second portion 71b which is the third foremost portion of the masking member 71.

With regard to the hinge 25 located at the rear right of the masking member 71, the contact surface 52 of the first pivotable plate 41 is brought into contact with the right first masking surface 74a of the first portion 71a which is the fourth foremost portion of the masking member 71, and the contact surface 52 of the second pivotable plate 42 is brought into contact with the right second masking surface 74b of the second portion 71b which is the fifth foremost (rearmost) portion of the masking member 71.

As has been described, the attaching step includes attaching hinges (fastened members) 25 to the coating jig 70 such that an exposure portion 62 of one of the hinges 25 (one of the fastened members) is in contact with one of the masking surfaces on one of the opposite sides (left side) of the masking member 71 and that an exposure portion 62 of another of the hinges 25 (another of the fastened members) is in contact with the other of the masking surfaces on the other of the opposite sides (right side) of the masking member 71. Specifically, the attaching step includes attaching hinges (fastened members) 25 to the coating jig 70 such that the exposure portion 62 of the first pivotable plate 41 is in contact with one of the masking surfaces of a corresponding first portion 71a and that the exposure portion 62 of the second pivotable plate 42 is in contact with one of the masking surfaces of a corresponding second portion 71b. With the surfaces and portions kept in contact with each other in such a manner, bolts (attaching fasteners) 76 and nuts 75 are used to fix the hinges 25 to the masking member 71, in the following manner.

With regard to the foremost second portion 71b of the masking member 71, the second pivotable plate 42 of the front left hinge 25 alone is fixed only to the left second masking surface 74b using two upper and lower bolts 76 and nuts 75.

With regard to the first portion 71a which is the second foremost portion of the masking member 71, the first pivotable plate 41 of the front left hinge 25 and the first pivotable plate 41 of the front right hinge 25 are fixed together to both the left and right sides using two upper and lower common bolts 76 and nuts 75.

With regard to the second portion 71b which is the third foremost portion of the masking member 71, the second pivotable plate 42 of the rear left hinge 25 and the second pivotable plate 42 of the front right hinge 25 are fixed together to both the left and right sides using two upper and lower common bolts 76 and nuts 75.

With regard to the first portion 71a which is the fourth foremost portion of the masking member 71, the first pivotable plate 41 of the rear left hinge 25 and the first pivotable plate 41 of the rear right hinge 25 are fixed together to both the left and right sides using two upper and lower common bolts 76 and nuts 75.

With regard to the rearmost second portion 71b of the masking member 71, the second pivotable plate 42 of the rear right hinge 25 alone is fixed only to the right second masking surface 74b using two upper and lower bolts 76 and nuts 75.

Referring to FIGS. 11 and 12, in the attaching step preceding coating, the foremost second portion 71b of the masking member 71 covers only the contact surface 52 of the second pivotable plate 42 of the front left hinge 25, the first portion 71a which is the second foremost portion of the masking member 71 covers the contact surface 52 of the first pivotable plate 41 of the front left hinge 25 and the contact surface 52 of the first pivotable plate 41 of the front right hinge 25, the second portion 71b which is the third foremost portion of the masking member 71 covers the contact surface 52 of the second pivotable plate 42 of the rear left hinge 25 and the contact surface 52 of the second pivotable plate 42 of the front right hinge 25, the first portion 71a which is the fourth foremost portion of the masking member 71 covers the contact surface 52 of the first pivotable plate 41 of the rear left hinge 25 and the contact surface 52 of the first pivotable plate 41 of the rear right hinge 25, and the rearmost second portion 71b of the masking member 71 covers only the contact surface 52 of the second pivotable plate 42 of the rear right hinge 25.

As illustrated in FIG. 12, in the coating step, one or more pairs of left and right coating nozzles 80a and 80b in a coating chamber are used to spray paint onto regions except for the covered regions of the hinges 25, from both the left and right sides of the masking member 71 and the hinges 25. The paint sprayed from the left coating nozzle(s) 80a forms a coating 51 on the obverse side of the first pivotable plates 41, the obverse side of the second pivotable plates 42, and the obverse side of the portions including the pins 40 of hinges 25. On the contrary, the paint sprayed from the right coating nozzle(s) 80b passes through the cutouts 73 to reach the reverse side of the pins 40, thus forming a coating 51 in the vicinities on the reverse side of the pins 40.

That is, the portion of each first pivotable plate 41 that is not in contact with any first masking surfaces, each pin 40, and the portion of each second pivotable plate 42 that is not in contact with any second masking surfaces are coated in the coating step. Note that a single coating nozzle may be used to coat the opposite surfaces of each hinge 25 instead of using one or more pairs of coating nozzles.

With the present embodiment, four hinges 25 are arranged on the left and right sides of a single masking member 71 in a distributed manner, and common bolts 76 and nuts are used to fix hinges 25 together to the first portions 71a and the second portions 71b except for the foremost and rearmost second portions 71b. This makes it possible to reduce the number of steps of attaching work using bolts 76 and reduce parts count, and possible to make the masking member 71 compact.

### Third Embodiment of Coating Jig

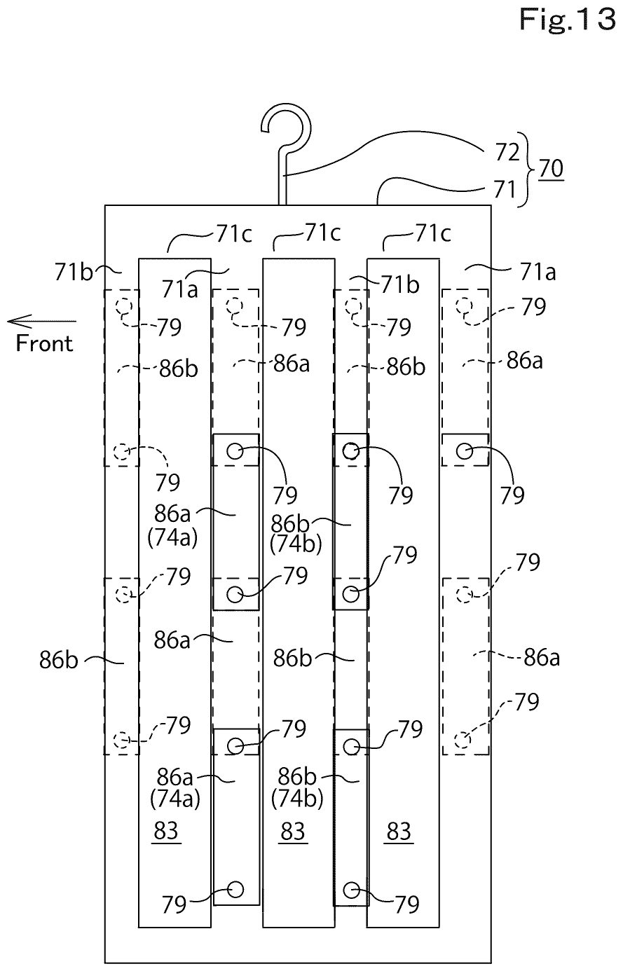

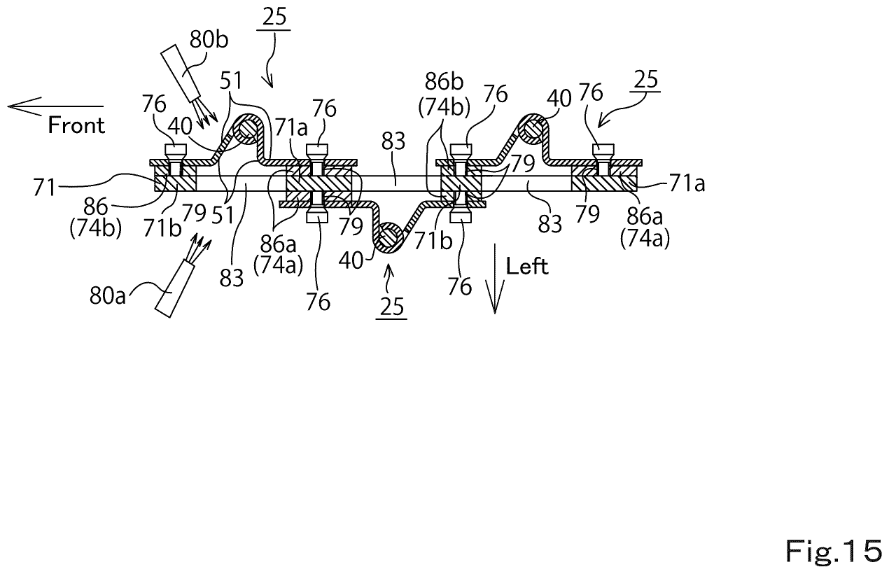

FIGS. 13 and 15 illustrate a third embodiment of a coating jig according to the present embodiment. The third embodiment of a coating jig will be described with reference to FIGS. 13 to 15. The same components and portions as those of the coating jig described in the first or second embodiment of the coating jig are assigned identical reference signs, and descriptions therefor are not repeated.

FIG. 13 is a side view of the coating jig 70 according to the third embodiment of the present invention. The coating jig 70 in FIG. 13 differs from the coating jig 70 according to the second embodiment in FIG. 11 in that the flat masking member 71 of the coating jig 70 in FIG. 13 has a rectangular shape extending lengthwise in the up-and-down direction, the coating jig 70 in FIG. 13 has three openings 83, each opening 83 extends lengthwise in the up-and-down direction, hinges 25 are arranged in a different manner from FIG. 11 on the left and right sides, and the first masking surfaces 74a and the second masking surfaces 74b are formed of first masking pieces 86a and second masking pieces 86b which are provided separately from the masking member 71. That is, the configuration in which a plurality of hinges 25 are attached on the left and right sides of a flat masking member 71 is the same as that of the foregoing coating jig 70 according to the second embodiment in FIG. 11.

As illustrated in FIG. 13, the flat masking member 71 has a rectangular shape extending lengthwise in the up-and-down direction, and has three openings 83. The flat masking member 71 includes a narrow second portion 71b, a third portion 71c including an opening 83, a wide first portion 71a, a third portion 71c including the central opening 83, a narrow second portion 71b, a third portion 71c including an opening 83, and the rearmost wide first portion 71a in this order from front. It is noted here that the masking member 71 includes first portions 71a each including first masking surface(s) 74a to cover the exposure portion(s) 62 of the first pivotable plate(s) 41, second portions 71b each including second masking surface(s) 74b to cover the exposure portion(s) 62 of the second pivotable plate(s) 42, and third portions 71c each located between a corresponding first portion 71a and a corresponding second portion 71b and including a corresponding opening 83 through which corresponding pin(s) 40 is/are exposed. Note that the number of the openings 83 is not limited to three, provided that the number is two or more.

In the present embodiment, the surface of the flat masking member 71 does not function directly as masking surfaces, and instead, the rectangular first masking pieces 86a each including a first masking surface 74a provided separately from the masking member 71 and the rectangular second masking pieces 86b each including a second masking surface 74b provided separately from the masking member 71 are fixed to the surfaces of the first portions 71a and the second portions 71b. It is noted here that the first and second masking pieces 86a and 86b include the first and second masking surfaces 74a and 74b whose areas are adjustable, respectively. With the configuration, the areas of the first and second masking surfaces 74a and 74b can be changed by adjusting the first and second masking pieces 86a and 86b, making it possible to easily and appropriately achieve masking (covering) according to the size of the desired regions. Furthermore, since the masking member 71 includes masking surfaces on both the opposite sides, it is possible to make the coating jig 70 compact and improve coating efficiency. Furthermore, the first masking pieces 86a and the second masking pieces 86b have screw holes 79 at the locations corresponding to bolt insertion holes 43 (see FIG. 5) of the hinges 25.

The masking member 71 is configured such that a plurality of rows of hinges 25 (in the present embodiment, four rows arranged in the up-and-down direction) are attached in a distributed manner on the left and right sides. At the uppermost row, first masking pieces 86a and second masking pieces 86b are fixed to the right sides of all the first portions 71a and the right sides of all the second portions 71b. At the second uppermost row, a first masking piece 86a and second a masking piece 86b are fixed to the left side of the first portion 71a (second foremost portion) and the second portion 71b (third foremost portion). The first masking piece 86a and the second masking piece 86b at the second row are arranged such that the screw holes 79 at the upper end portions thereof are concentric with the screw holes 79 in the lower end portions of a corresponding first masking piece 86a and a corresponding second masking piece 86b at the uppermost row. At the third row, similarly to the uppermost row, first masking pieces 86a and second masking pieces 86b are fixed to the right sides of all the first portions 71a and the right sides of all the second portions 71b. At the fourth row (lowest row), a first masking piece 86a and a second masking piece 86b are fixed to the left side of the first portion 71a (second foremost portion) and the left side of the second portion 71b (third foremost portion).

The first masking piece(s) 86a and the second masking piece(s) 86b at each of the third and fourth rows, similarly to the second row, are arranged such that screw holes 79 at the upper end portions are concentric with the screw holes 79 at the lower end portions of a corresponding first masking piece 86a and a corresponding second masking piece 86b at the row immediately above.

### Attaching and Coating Hinges 25, and Effects Thereof

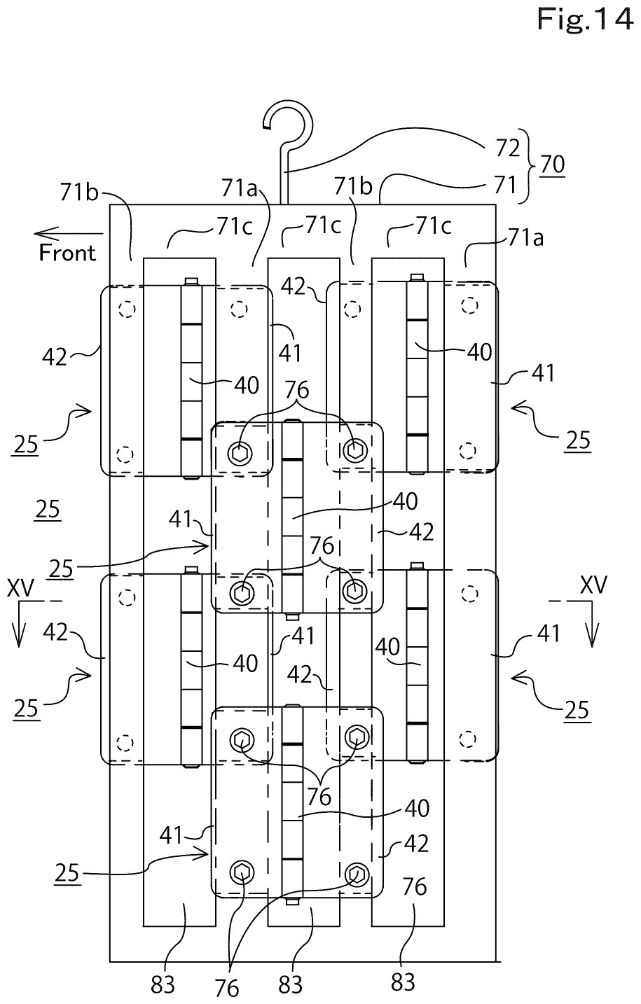

FIG. 14 is a side view of the coating jig 70 in FIG. 13 to which hinges 25 are attached. FIG. 15 is a cross-sectional view taken along line XV-XV in FIG. 14.

As illustrated in FIG. 14, in the attaching step prior to coating hinges 25, two hinges 25 are attached to the right side (surface on the far side in FIG. 14) of the masking member 71 using bolts (attaching fasteners) 76 at each of the uppermost and third uppermost rows, and one hinge 25 is attached to the central portion in the front-rear direction using bolts 76 at each of the second and fourth rows.

As illustrated in FIG. 15, the method of coating hinges 25 is the same as the foregoing second embodiment. The coating nozzles 80a and 80b arranged on the left and right sides in a coating chamber are used to coat the entire peripheral surface of the masking member 71 except for the covered exposure portions to form a coating 51.

With the coating jig 70 according to the above embodiment, the first masking pieces 86a and the second masking pieces 86b provided separately from the masking member 71 include the first masking surfaces 74a and the second masking surfaces 74b. Therefore, by changing the sizes of the first masking pieces 86a and the second masking pieces 86b to different sizes, it is possible, without having to change the masking member 71 itself, to adjust the areas of the first masking surfaces 74a and the second masking surfaces 74b, i.e., easily change the areas of the covered regions.

### Fourth Embodiment of Coating Jig

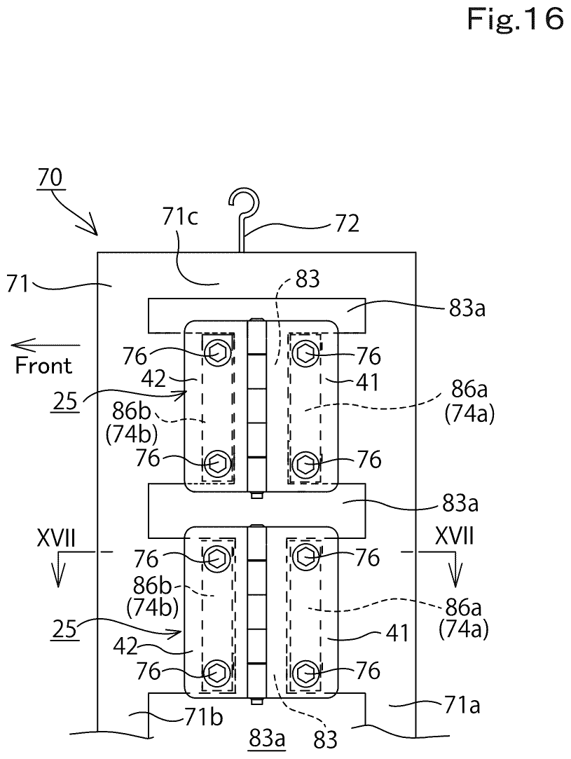

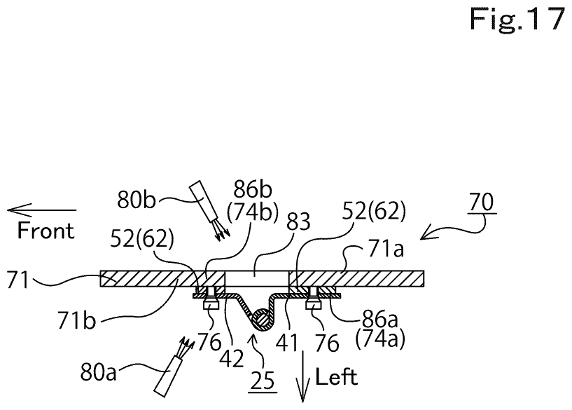

FIG. 16 is a side view of a coating jig 70 according to a fourth embodiment of the present invention to which hinges 25 are attached. FIG. 17 is a cross-sectional view taken along line XVII-XVII in FIG. 16.

The coating jig 70 in FIG. 16 is configured as if a plurality of the masking members 71 of the coating jig 70 according to the first embodiment in FIG. 8 were connected together in the up-and-down direction. The coating jig 70 in FIG. 16 differs from the coating jig 70 according to the first embodiment in FIG. 10 in that the coating jig 70 in FIG. 16 has openings 83 instead of the cutout 73, elongated opening portions 83a each of which extends widthwise in the front-rear direction are provided at the portions corresponding to the upper and lower end portions of the attached hinges 25, and the coating jig 70 in FIG. 16 includes first masking pieces 86a and second masking pieces 86b. It is noted here that the masking member 71 includes a first portion 71a including first masking surfaces 74a to cover the exposure portions 62 of first pivotable plates 41, a second portion 71b including second masking surfaces 74b to cover the exposure portions 62 of second pivotable plates 42, and a third portion 71c that is located between the first portion 71a and the second portion 71b and that includes the openings 83 through which pins 40 are exposed.

It is noted here that the same components and portions as those of the coating jig 70 described in any of the first to third embodiments are assigned identical reference signs, and descriptions therefor are not repeated.

As illustrated in FIG. 17, the method of coating hinges 25 is the same as the foregoing first embodiment. The coating nozzles 80a and 80b arranged on the left and rights sides in a coating chamber are used to coat the entire peripheral surface of the masking member 71 except for the covered exposure portions to form a coating 51.

With the coating jig 70 according to the above embodiment, a plurality of hinges are attached to a single masking member 71, making it possible to improve coating efficiency. Furthermore, since the elongated opening portions 83a are provided at the upper and lower ends of the openings 83, it is possible to form a good quality coating 51 also on the upper and lower end portions and their vicinities of each hinge 25 without leaving uncoated portions.

Furthermore, the first masking surfaces 74a and the second masking surfaces 74b are provided on the first masking pieces 86a and the second masking pieces 86b provided separately from the masking member 71. Therefore, by changing the sizes of the first masking pieces 86a and the second masking pieces 86b to different sizes, it is possible, without having to change the masking member 71 itself, to change the areas of the covered regions.

### Fifth Embodiment of Coating Jig

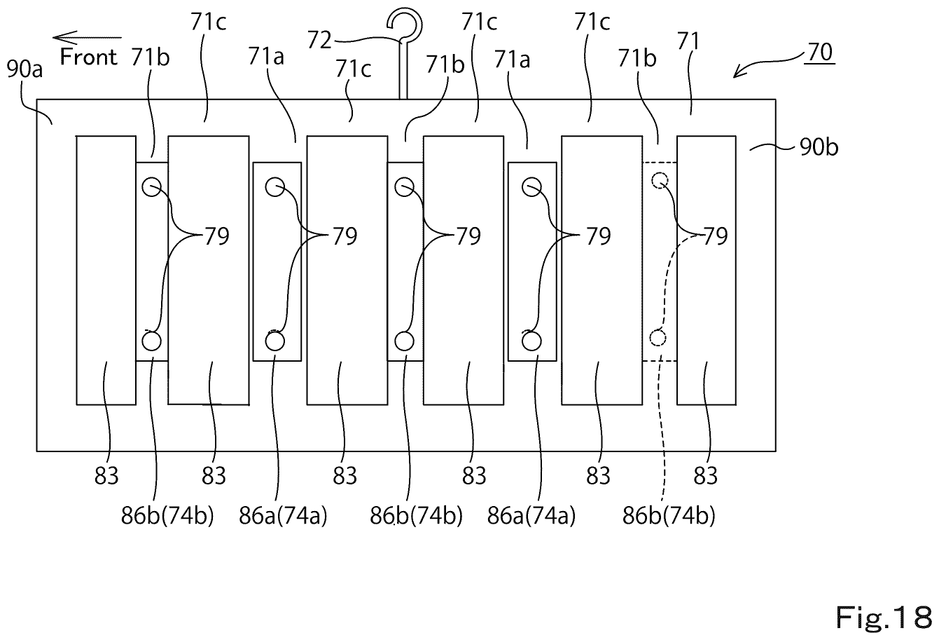

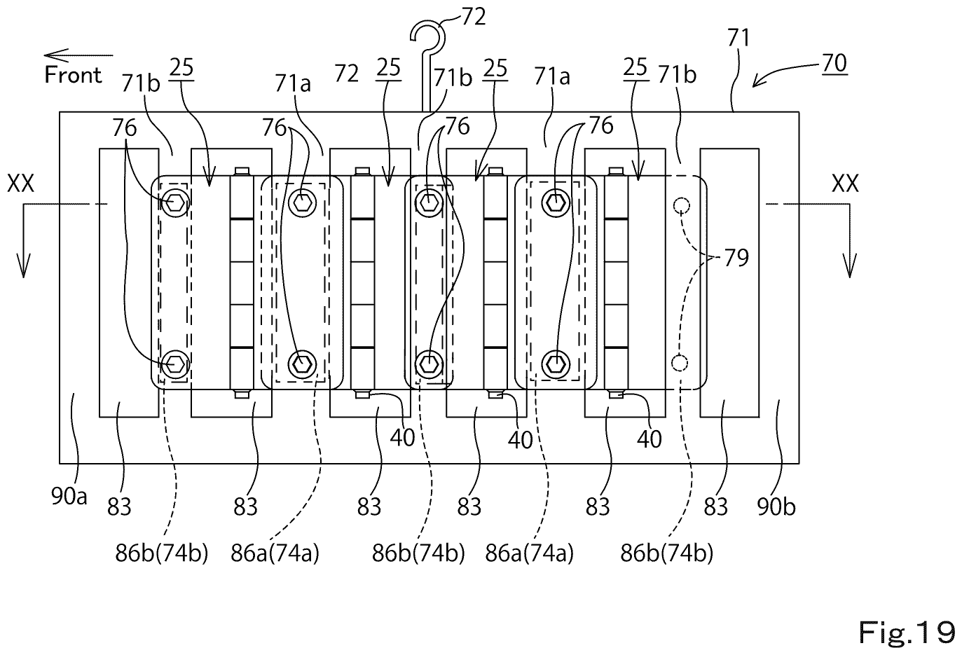

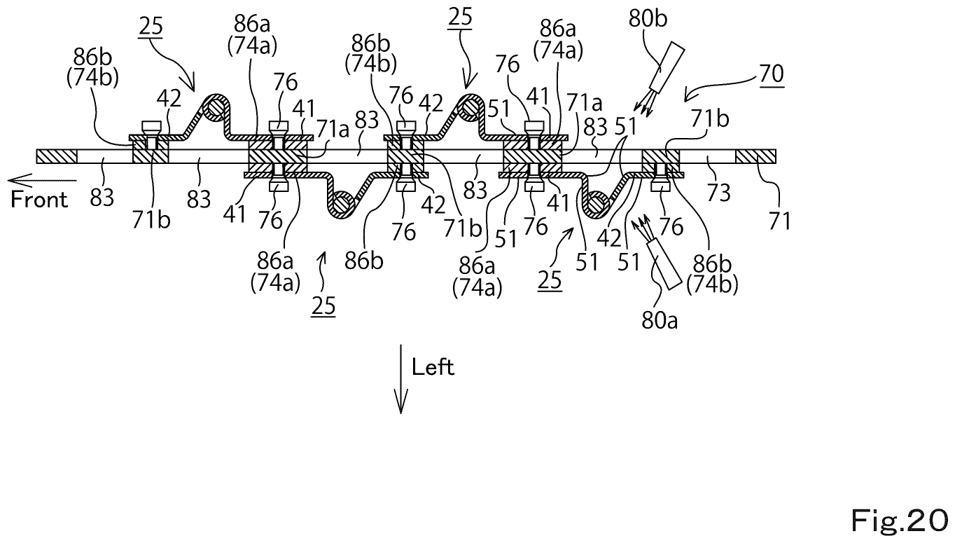

FIG. 18 is a side view of a coating jig 70 according to a fifth embodiment of the present invention. FIG. 19 is a side view of the coating jig 70 in FIG. 18 to which hinges are attached. FIG. 20 is a cross-sectional view taken along line XX-XX in FIG. 19.

The coating jig 70 in FIG. 18 is configured as if a plurality of the masking members 71 of the coating jig 70 according to the first embodiment in FIG. 8 were connected together in the front-rear direction. The coating jig 70 in FIG. 18 differs from the coating jig 70 according to the first embodiment in FIG. 10 in that the coating jig 70 in FIG. 18 includes openings 83 instead of the cutout 73, and the coating jig 70 in FIG. 18 includes first masking pieces 86a and second masking pieces 86b on the left and right sides of the masking member 71. It is noted here that the masking member 71 includes first portions 71a each including a first masking surface 74a to cover the exposure portion 62 of a first pivotable plate 41, second portions 71b each including a second masking surface 74b to cover the exposure portion 62 of a second pivotable plate 42, and third portion 71c each located between a corresponding first portion 71a and a corresponding second portion 71b and including a corresponding opening 83 through which a pin 40 is exposed. The same components and portions as those of the coating jig 70 describe in any of the first to fourth embodiments are assigned identical reference signs, and descriptions therefor are not repeated.

In FIG. 18, the flat masking member 71 has a rectangular shape extending lengthwise in the front-rear direction, and includes two or more openings 83 and three or more columnar portions. In the present embodiment, the number of the openings 83 is six, and the number of the columnar portions is seven. The foremost portion 90a and the rearmost portion 90b located at the foremost position and the seventh foremost position (rearmost position) are not particularly used as masking surfaces, the second foremost to sixth foremost portions are used as masking surfaces. Specifically, the second foremost portion is a narrow second portion 71b, and is provided with a second masking piece 86b including a second masking surface 74b only on the left side. The third foremost portion is a wide first portion 71a, and is provided with first masking pieces 86a including first masking surfaces 74a on both the left and right sides. The fourth foremost portion is a narrow second portion 71b, and is provided with second masking pieces 86b including second masking surfaces 74b on both the left and right sides. The fifth foremost portion is a wide first portion 71a, and is provided with first masking pieces 86a including first masking surfaces 74a on both the left and right sides. The sixth foremost portion is a narrow second portion 71b, and is provided with a second masking piece 86b including a second masking surface 74b only on the right side. Note that the first masking pieces 86a and the second masking pieces 86b each have a pair of upper and lower screw holes 79.

### (Attaching and Coating Hinges 25, and Effect(s) Thereof)

FIG. 19 illustrates the coating jig 70 to which the hinges 25 are attached. Two hinges 25 are arranged on the left side of the masking member 71, and one of the hinges 25 is attached via bolts 76 to the second masking piece 86b on the second portion 71b which is the second foremost portion and the first masking piece 86a on the first portion 71a which is the third foremost portion. The other of the hinges 25 is attached via bolts 76 to the second masking piece 86b on the second portion 71b which is the fourth foremost portion and the first masking piece 86a on the first portion 71a which is the fifth foremost portion.

On the other hand, at the right side of the masking member 71, one hinge 25 is attached via bolts 76 to the first masking piece 86a on the first portion 71a which is the third foremost portion and the second masking piece 86b on the second portion 71b which is the fourth foremost portion. The last one hinge 25 is attached via bolts 76 to the first masking piece 86a on the first portion 71a which is the fifth foremost portion and the second masking piece 86b on the second portion 71b which is the sixth foremost portion. That is, the four hinges 25 in total are attached in a distributed manner on the left and right sides of the masking member 71.

As illustrated in FIG. 20, the method of coating hinges 25 is the same as the foregoing first embodiment. The coating nozzles 80a and 80b located on the left and right sides in a coating chamber are used to coat the entire peripheral surface except for the covered exposure portions of the masking member 71 to form a coating 51.

Note that, in the present embodiment, the hook 72 may be provided at a short edge of the masking member 71 such that the masking member 71 as a whole has a rectangular shape extending lengthwise in the up-and-down direction.

### (Variations of Coating Jig)

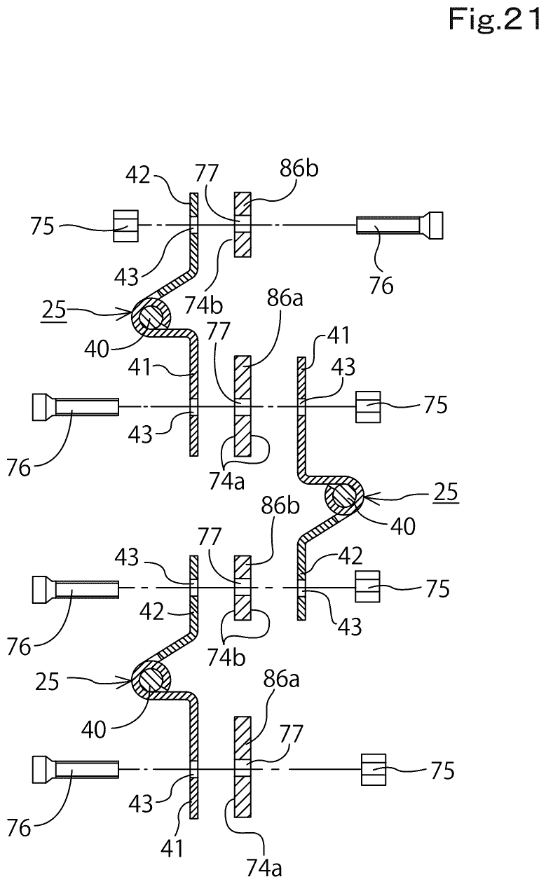

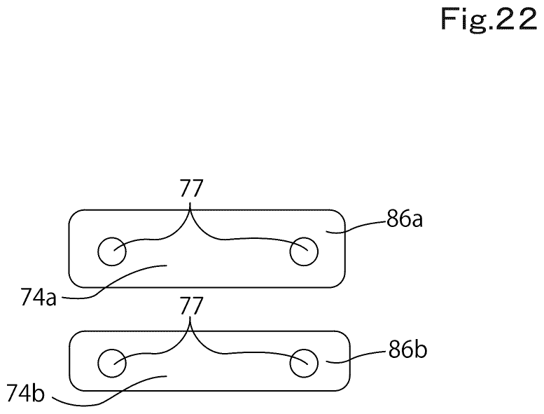

FIG. 21 is a side view of a coating jig according to a variation of the present invention. FIG. 22 is a side view of a first masking piece 86a and a second masking piece 86b in FIG. 21. As illustrated in FIGS. 21 and 22, the coating jig according to a variation is configured such that the first masking pieces 86a each including a first masking surface 74a and the second masking pieces 86b each including a second masking surface 74b used in the third embodiment of the coating jig only are used to connect hinges 25 together, thus achieving masking (covering). The side surfaces of the first masking pieces 86a and the second masking pieces 86b are provided with bolt insertion holes 77 at opposite end portions in the lengthwise direction.

As illustrated in FIG. 21, three hinges 25 are connected together. One of the second masking pieces 86b is brought into contact with the contact surface 52 of the second pivotable plate 42 of the top hinge 25 and fixed with bolts 76 and nuts 75. One of the first masking pieces 86a is provided between the contact surface 52 of the first pivotable plate 41 of the top hinge 25 and the contact surface 52 of the first pivotable plate 41 of the middle hinge 25, and the first pivotable plates 41 are connected via bolts 76 and nuts 75. Another of the second masking pieces 86b is provided between the contact surface 52 of the second pivotable plate 42 of the middle hinge 25 and the contact surface 52 of the second pivotable plate 42 of the bottom hinge 25, and the second pivotable plates 42 are connected together via bolts 76 and nuts 75. At last, another of the first masking pieces 86a is brought into contact with the contact surface 52 of the first pivotable plate 41 of the bottom hinge 25, and fixed with bolts 76 and nuts 75. Note that the contact surface 52 of the first pivotable plate 41 of the top hinge 25 and the contact surface 52 of the first pivotable plate 41 of the middle hinge may be brought into direct contact with each other and the first pivotable plates 41 may be connected together via bolts 76 and nuts 75, and the contact surface 52 of the second pivotable plate 42 of the middle hinge 25 and the contact surface 52 of the second pivotable plate 42 of the bottom hinge 25 may be brought into direct contact with each other and the second pivotable plates 42 may be connected together via bolts 76 and nuts 75. That is, a portion of a single hinge 25 may function as a masking member for use in coating another hinge 25.

Note that, in the coating step involving coating hinges 25, a hook is provided on bolt(s) 76 to fix a corresponding second masking piece 86b at the top row and the hinges 25 are supplied to a coating chamber. Note that in the configuration of the present variation, four or more hinges 25 may be connected together.

As has been discussed, a fastened member according to a first aspect is a metal fastened member to be fastened with at least one fastener to at least one attachment surface of at least one target object to which the fastened member is to be attached, the at least one target object containing steel, the fastened member including: at least one contact surface to make contact with the at least one attachment surface, the at least one contact surface at least partially including at least one exposure portion where material having a higher ionization tendency than steel is exposed, wherein a portion of the fastened member that is other than the at least one contact surface is coated with a coating.

With the fastened member according to the first aspect, even if water, mud and/or the like enters the gap between the attachment surface(s) of the target object(s) and the contact surface(s) of the fastened member, since the material having a higher ionization tendency than steel is exposed, the material in the exposure portion(s) acts as a sacrificial anode. With this, it is possible to eliminate or reduce the likelihood that attachment surface(s) of the target object(s) will rust, and also the interior of the fastened member is also protected by the material in the exposure portion(s), so that rusting is prevented.

The fastened member according to the first aspect may include at least one of the following features (a) to (e).
(a) The at least one contact surface is coated with the coating except for the at least one exposure portion.

With the configuration, by coating a desired portion of the contact surface(s), it is possible to maintain good appearance after the attachment to the target object(s) and reduce the amount of water entering the exposure portion(s).
(b) The at least one contact surface has at least one insertion hole for insertion of the at least one fastener.

With the configuration, the following is achieved. Usually, insertion holes are likely to be the entrance for water entering the gap between the contact surface(s) and the attachment surface(s), and rust is likely to occur in the vicinity of the insertion hole(s). However, even when the fastened member has such insertion hole(s), it is still possible to maintain the antirust effect, especially the effect of preventing rust in the vicinity of the insertion hole(s).
(c) The fastened member is a hinge including a pin and first and second pivotable plates coupled to each other via the pin such that the first and second pivotable plates are pivotable relative to each other.

With the configuration, even in the case of a hinge having a complex structure which is pivotable, it is possible to prevent rusting of the entire hinge because of the coating and the exposure portion(s) including the material with high ionization tendency.
(d) The at least one contact surface is plated with a layer of the material having a higher ionization tendency than steel, and the layer of the material is exposed in the at least one exposure portion.

With the configuration, even if water, mud and/or the like enters the gap between the attachment surface(s) of the target object(s) and the contact surface(s) of the fastened member, since the material having a higher ionization tendency than steel is exposed, the material in the exposure portion(s) acts as a sacrificial anode. With this, it is possible to eliminate or reduce the likelihood that attachment surface(s) of the target object(s) will rust. Furthermore, the interior of the fastened member is also protected by the material in the exposure portion(s), so that rusting is prevented.
(e) The at least one contact surface is provided with a thin sheet at least a surface of which contains the material having a higher ionization tendency than steel, and the surface of the thin sheet is exposed in the at least one exposure portion.

The configuration makes it possible to easily form the exposure portion(s) at low cost.

A coating jig according to a second aspect of the present invention is a coating jig for use in coating at least one fastened member according to the first aspect, the coating jig including a masking member having at least one masking surface to contact and cover the at least one exposure portion of the at least one fastened member.

With the configuration, since the coating jig itself is provided with the masking surface(s) and has the fastened member(s) attached thereto, it is possible to attach and cover the fastened member(s) at the same time, making it possible to simplify the work of attaching fastened member(s) for coating.

The coating jig according to the second aspect may include at least one masking piece including the at least one masking surface whose area is adjustable and/or may be configured such that the masking member is a plate and the plate has the at least one masking surface on each of opposite sides thereof.

With the configuration, since the area of the masking surface(s) can be changed by adjusting the masking piece(s), it is possible to easily and appropriately achieve masking (covering) according to the size of the desired region(s). Since the masking member has the masking surface(s) on each of the opposite sides thereof, it is possible to make the coating jig compact and improve the efficiency of coating work.

A coating method according to a third aspect of the present invention is a method of coating the at least one fastened member according to the first aspect using the coating jig according to the second aspect, the method including: an attaching step including attaching the at least one fastened member to the coating jig before performing coating such that the at least one contact surface is in contact with the at least one masking surface to cover the at least one contact surface with the at least one masking surface; and a coating step including, after the attaching step, coating both of opposite sides of the at least one fastened member except for a covered region.

In the coating method according to the third aspect, a peripheral portion of the at least one contact surface may be left exposed without being covered, and the peripheral portion of the at least one contact surface may be coated in the coating step.

### (Other Examples of Fastened Member and Coating Jig)

(1) Hinge(s) may be attached to a coating jig using magnet(s) instead of or in addition to bolt(s).

(2) It is understood that the fastened member(s) and the coating jig are applicable not only to hinges for the door of the cabin of a backhoe but also to those of constructing machines such as power shovels, and agricultural machines such as tractors and large-size combines. The fastened member may be, for example, a mounting bracket to attach component(s) to the exterior surface of a construction machine, a working vehicle, or a working machine. Examples include handles, handrails, and lids of fuel fillers.

(3) A hinge may be plated entirely with a layer of, for example, zinc and then, in the coating step, the entire region of the hinge except for the exposure portion(s) of the contact surface(s) may be coated. That is, in the contact surface(s), the layer of zinc etc. is present under the coating. This improve the antirust effect.

(4) While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A fastened member which is a metal fastened member to be fastened with at least one fastener to at least one attachment surface of at least one target object to which the fastened member is to be attached, the at least one target object containing steel, the fastened member comprising:
at least one contact surface to make contact with the at least one attachment surface, the at least one contact surface at least partially including at least one exposure portion where material having a higher ionization tendency than steel is exposed, wherein
a portion of the fastened member that is other than the at least one contact surface is coated with a coating.

2. The fastened member according to claim 1, wherein the at least one contact surface is coated with the coating except for the at least one exposure portion.

3. The fastened member according to claim 1, wherein the at least one contact surface has at least one insertion hole for insertion of the at least one fastener.

4. The fastened member according to claim 1, wherein the fastened member is a hinge including a pin and first and second pivotable plates coupled to each other via the pin such that the first and second pivotable plates are pivotable relative to each other.

5. The fastened member according to claim 1, wherein the at least one contact surface is plated with a layer of the material having a higher ionization tendency than steel, and the layer of the material is exposed in the at least one exposure portion.

6. The fastened member according to claim 1, wherein the at least one contact surface is provided with a thin sheet at least a surface of which contains the material having a higher ionization tendency than steel, and the surface of the thin sheet is exposed in the at least one exposure portion.

7. A coating jig for at least one fastened member according to claim 1, the coating jig comprising:
a masking member having at least one masking surface to contact and cover the at least one exposure portion of the at least one fastened member.

8. The coating jig according to claim 7, further comprising at least one masking piece including the at least one masking surface whose area is adjustable.

9. The coating jig according to claim 7, wherein:
the masking member is a plate; and
the plate has the at least one masking surface on each of opposite sides thereof.

10. The coating jig according to claim 7, wherein:
the at least one fastened member is at least one hinge each including a pin and first and second pivotable plates coupled to each other via the pin such that the first and second pivotable plates are pivotable relative to each other; and
the coating jig, in which a plurality of the masking surfaces include at least one first masking surface and at least one second masking surface, includes
at least one first portion including the at least one first masking surface to cover the at least one exposure portion of the first pivotable plate,
at least one second portion including the at least one second masking surface to cover the at least one exposure portion of the second pivotable plate, and
at least one third portion located between the at least one first portion and the at least one second portion and each including at least one opening or at least one cutout through which the pin is exposed.

11. The coating jig according to claim 7, wherein the coating jig includes a plurality of the masking surfaces, and is configured such that
when the number of the at least one fastened member is one and the one fastened member includes a plurality of the exposure portions, the plurality of masking surfaces cover the plurality of exposure portions of the one fastened member at the same time, or
when the number of the at least one fastened member is two or more, the plurality of masking surfaces cover the at least one exposure portion of each of the two or more fastened members at the same time.

12. A method of coating the at least one fastened member using the coating jig according to claim 7, the method comprising:
an attaching step including attaching the at least one fastened member to the coating jig before performing coating such that the at least one exposure portion is in contact with the at least one masking surface; and
a coating step including, after the attaching step, coating the at least one fastened member attached to the coating jig.

13. The method according to claim 12, wherein:
the attaching step includes allowing a peripheral portion of the at least one contact surface to be left exposed without being covered; and
the coating step includes coating the peripheral portion of the at least one contact surface.

14. The method according to claim 12, wherein:
the masking member is a plate which has the at least one masking surface on each of opposite sides thereof;
the attaching step includes attaching a plurality of the fastened members to the coating jig such that the at least one exposure portion of at least one of the plurality of fastened members is in contact with the at least one masking surface on one of the opposite sides of the masking member and that the at least one exposure portion of at least another of the plurality of fastened members is in contact with the at least one masking surface on the other of the opposite sides of the masking member; and
the coating step includes coating the at least one of the plurality of fastened members and the at least another of the plurality of fastened members.

15. The method according to claim 12, wherein:
the at least one fastened member is at least one hinge each including a pin and first and second pivotable plates coupled to each other via the pin such that the first and second pivotable plates are pivotable relative to each other;
the coating jig, in which a plurality of the masking surfaces include at least one first masking surface and at least one second masking surface, includes
at least one first portion including the at least one first masking surface to cover the at least one exposure portion of the first pivotable plate,
at least one second portion including the at least one second masking surface to cover the at least one exposure portion of the second pivotable plate, and
at least one third portion located between the at least one first portion and the at least one second portion and each including at least one opening or at least one cutout through which the pin is exposed;
the attaching step includes attaching the at least one fastened member to the coating jig such that the at least one exposure portion of the first pivotable plate is in contact with the at least one first masking surface of the at least one first portion, and the at least one exposure portion of the second pivotable plate is in contact with the at least one second masking surface of the at least one second portion; and
the coating step includes coating a portion of the first pivotable plate that is not in contact with the at least one first masking surface, the pin, and a portion of the second pivotable plate that is not in contact with the at least one second masking surface.

16. The method according to claim 15, wherein:
the at least one first portion and the at least one second portion are plates;
the at least one first portion has the at least one first masking surface on one of opposite sides thereof, and has, on the other of the opposite sides thereof, one of (i) at least one other first masking surface and (ii) at least one other second masking surface;
the at least one second portion has the at least one second masking surface on one of opposite sides thereof, and has, on the other of the opposite sides thereof, the other of (i) the at least one other first masking surface and (ii) the at least one other second masking surface;
the attaching step includes
allowing the at least one exposure portion of the first pivotable plate of at least one of a plurality of the fastened members to be in contact with the at least one first masking surface on the one of the opposite sides of the at least one first portion, and allowing the at least one exposure portion of the second pivotable plate of the at least one of the plurality of fastened members to be in contact with the at least one second masking surface on the one of the opposite sides of the at least one second portion,
when the at least one other first masking surface is on the other of the opposite sides of the at least one first portion, allowing the at least one exposure portion of the first pivotable plate of at least another of the plurality of fastened members to be in contact with the at least one other first masking surface, and allowing the at least one exposure portion of the second pivotable plate of the at least another of the plurality of fastened members to be in contact with the at least one other second masking surface on the other of the opposite sides of the at least one second portion, and
when the at least one other second masking surface is on the other of the opposite sides of the at least one first portion, allowing the at least one exposure portion of the second pivotable plate of the at least another of the plurality of fastened members to be in contact with the at least one other second masking surface, and allowing the at least one exposure portion of the first pivotable plate of the at least another of the plurality of fastened members to be in contact with the at least one other first masking surface on the other of the opposite sides of the at least one second portion; and
the coating step includes coating a portion of the first pivotable plate that is not in contact with the at least one first masking surface, the pin, and a portion of the second pivotable plate that is not in contact with the at least one second masking surface, of each of the at least one of the plurality of fastened members and the at least another of the plurality of fastened members.

17. The method according to claim 12, wherein:
the coating jig includes a plurality of the masking surfaces;
the attaching step includes attaching a plurality of the fastened members to the coating jig such that the at least one exposure portion of each of the plurality of fastened members is in contact with any of the plurality of masking surfaces; and
the coating step includes coating each of the plurality of fastened members.

18. The method according to claim 12, wherein:
the at least one fastened member has at least one insertion hole for insertion of the at least one fastener; and
the attaching step includes attaching the at least one fastened member to the coating jig by inserting the at least one fastener for attachment into the at least one insertion hole.

19. The method according to claim 18, wherein:
the masking member is a plate which has the at least one masking surface on each of opposite sides thereof; and
the attaching step includes, by inserting the at least one fastener into the at least one insertion hole of at least one of a plurality of the fastened members and into the at least one insertion hole of at least another of the plurality of fastened members such that the masking member is provided between the at least one of the plurality of fastened members and the at least another of the plurality of fastened members, attaching the at least one of the plurality of fastened members and the at least another of the plurality of the fastened members to the coating jig.
